(19) United States
(12) Patent Application Publication
(10) Pub. No.: US 2010/0300233 A1
(43) Pub. Date: Dec. 2, 2010

(54) ACTUATOR FOR SHIFT PATH SELECTION IN AN AUTOMATED TRANSMISSION OF A MOTOR VEHICLE

(75) Inventor: Kai HEINRICH, Waldburg (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/779,320

(22) Filed: May 13, 2010

(30) Foreign Application Priority Data
May 28, 2009 (DE) 10 2009 026 544.9

(51) Int. Cl. F16H 61/32

(52) U.S. Cl. 74/473.12

(57) ABSTRACT

A shift gate selector for an automated transmission of a motor vehicle comprises a selector rod (1) and first and second electromagnetic actuators (M1, M2) made as 2-position magnets, in particular bistable position magnets, which are actively connected to the selector rod (1) and are arranged in such a manner that depending on the combination of the positions of the actuators (M1, M2), one of four possible selection positions is obtained, each corresponding to a gate (W1, W2, W3, W4) to be selected.

This application claims priority from German patent application serial no. 10 2009 026 544.9 filed May 28, 2009.

### FIELD OF THE INVENTION

The present invention relates to a shift gate selector for an automated transmission of a motor vehicle.

### BACKGROUND OF THE INVENTION

In automated change-speed transmissions, according to the prior art the gate selection takes place by means of various actuator concepts. For example, the shift gate selector can be designed to be actuated by an electric motor with ball-type rotary spindles, or electrohydraulically, electromagnetically or electropneumatically, and can be in driving connection with the shifting shaft either directly or via adjustment gearing.

Depending on the number of gears in the main transmission, a choice is to be made between at least two gates and when the gate selector is actuated by an electric motor, electrohydraulically or electropneumatically, this enables continuous positioning between the mechanical limits, resulting in the need for path determination and position regulation in order to enter the desired gate reliably.

Disadvantageously, electropneumatically actuated selectors are prone to damage; furthermore, the production and assembly costs for electric motor and electro-hydraulically actuated selectors are high. In addition, in the case of electromagnetically actuated selectors, owing to the physical mode of operation continuous positioning without a counterforce can only be achieved with considerable design and construction effort.

For the case of selection between two gates, it is known from the prior art to use a bistable, reversing lifting magnet (1/R, 2/3), while for the case of selection between three gates an additional, central position is provided by design in order to be able to select between select three gates (1/2, R, 3/4). Unfortunately, an actuator of similar structure cannot be used to select between more than three gates.

From DE 602 07 899 T2 a shift actuator for a transmission is known, which in one shift direction actuates a shift lever of the transmission, the shift actuator comprises a working rod which is engaged with a working element connected to the shift lever, a cylindrically fixed yoke which surrounds the working rod and a pair of coils which are arranged adjacent to one another in the axial direction on the inside of the fixed yoke. In this known shift actuator magnetic movement means are arranged on the surface of the outside circumference in order to move the working rod axially, the magnetic movement means comprising an annular permanent magnet which moves together with the working rod and faces toward the two coils.

In this device it is known to position the selector actuator by means of an upwardly graded spring packet with different spring constants and suitable regulation means, in each case always up to the contact point of the next-higher spring, so as to select the corresponding gate. As soon as the electromagnet has been deactivated, the full restoring force of the spring packet acts on a locking plate provided, and this can result in severe wear. With such a design, selection reliability and the regulation demanded for it are difficult to ensure; for complete selector movement over four gates a magnet with an overall stroke on the order of 28 mm is provided, which disadvantageously results in a magnet of large dimensions.

### SUMMARY OF THE INVENTION

The purpose of the present invention is to describe a shift gate selector for an automated transmission of a motor vehicle, by virtue of which the high costs and complexity of continuous positioning are avoided, and discrete, reaction-free positions are maintained for each gate. In addition, it should be possible to select between four gates with a reduced selection stroke in the selector and with the same selection path in the gate.

Accordingly, a shift gate selector for an automated motor vehicle transmission is proposed, which comprises a selector rod and two electromagnetic actuators made as 2-position magnets and actively connected to the selector rod, which are arranged in such manner that depending on the combination of the actuator positions one of four possible selector positions is obtained, each corresponding to a particular gate selected. The 2-position magnets can in particular be made as bistable positioning magnets in order to minimize their energy consumption once they have reached their positions.

Thanks to the concept according to the invention, four discrete selector positions can advantageously be assumed reliably and with little control and regulation effort or complexity.

The selector comprises a selector rod such that one end of the rod is arranged in the shifting device for selecting the gates and is connected to a carrier element, while at the other end of the selector rod a slot arranged coaxially with the longitudinal axis of the rod is provided, in which is held a guide pin connected to a push-rod of a first electromagnetic actuator comprising a 2-position magnet.

In addition, between the two ends of the selector rod and preferably at the middle of the rod as viewed axially, an opening is provided in which is held a guide pin connected to a push-rod of a second electromagnetic actuator comprising a 2-position magnet.

The two actuators are preferably of identical structure and, in an advantageous embodiment of the invention, are arranged on one side of the selector rod relative to its longitudinal axis and in one plane, in such manner that their push-rods are parallel to one another so that, as viewed in the longitudinal direction of the push-rods, the end positions of the push-rods that correspond to the respective positions are the same for the same positions.

According to a particularly advantageous embodiment of the invention, it is provided that in the selector positions that correspond to the two middle gates the push-rods of the actuators are arranged essentially perpendicularly to the selector rod, the positions of the two actuators being the same in each case.

For selecting the two outer gates, the two actuators have respectively opposite positions so that the selector rod forms an angle with the push-rods of the actuators which is larger or smaller than 90°.

In a further embodiment of the invention, relative to the longitudinal axis of the selector rod the actuators can be arranged on respectively opposite sides of the selector rod and in the same plane; in this configuration the objective of the invention is achieved by virtue of different push-rod lengths and different paths between the individual positions of the actuators.

### BRIEF DESCRIPTION OF THE DRAWINGS

Below, an example of the invention is described in greater detail with reference to the attached figures, which show:

FIG. 1: Schematic representation of the arrangement of the actuators and the selector rod of the gate selector according to the invention, according to a preferred embodiment of the invention, to make clear the four selector positions that can be obtained

FIG. 2: Schematic view of the gate selector according to the invention, in the preferred embodiment of the invention shown in FIG. 1

FIG. 3: Table to make clear the required actuator positions for selecting the various gates; and

FIGS. 4A, 4B and 4C: Schematic indication of the shift conditions and the corresponding movements of the actuators for selecting the third gate, the fourth gate and the first gate, starting in each case from the second gate

### DETAILED DESCRIPTION OF THE PREFERRED EMBODIMENTS

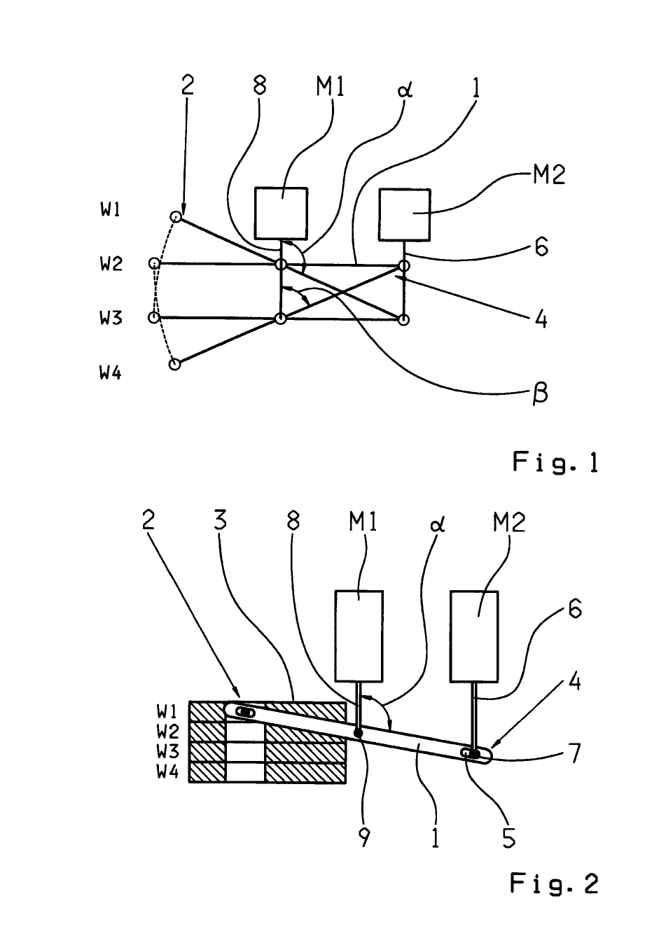

Referring to FIGS. 1 and 2, the gate selector according to the invention comprises a selector rod 1, one end 2 of which is arranged in the shifting device 3 of the transmission for selecting the gates and is connected to a carrier element, while at the other end 4 of the selector rod 1 a slot 5 coaxial with the longitudinal axis of the selector rod 1 is provided, in which is held a guide pin 7 connected to the push-rod 6 of a first electromagnetic actuator M1, the latter being made as a bistable 2-position magnet.

As can be seen from FIGS. 1 and 2, in the middle of the selector rod 1 as viewed axially an opening is provided, in which is held a guide pin 9 connected to the push-rod 8 of a second electromagnetic actuator M2 also made as a bistable 2-position magnet.

The electromagnetic actuators M1 and M2 are of identical structure and, relative to the longitudinal axis of the selector rod 1, are arranged on the same side of the selector rod 1 and in the same plane, so that the push-rods 6, 8 are parallel to one another; furthermore, as viewed in the longitudinal direction of the push-rods, the end positions of the push-rods 6, 8 that correspond to respective actuator positions are the same for the same such positions. Moreover, the respective push-rods 8, 6 of the actuators M1, M2 are arranged essentially perpendicularly to the planes defined by the gates W1, W2, W3 and W4 to be selected.

Depending on the combination of the positions of the actuators M1 and M2, one of the selection positions corresponding to the gates W1, W2, W3 and W4 can be obtained, as explained below.

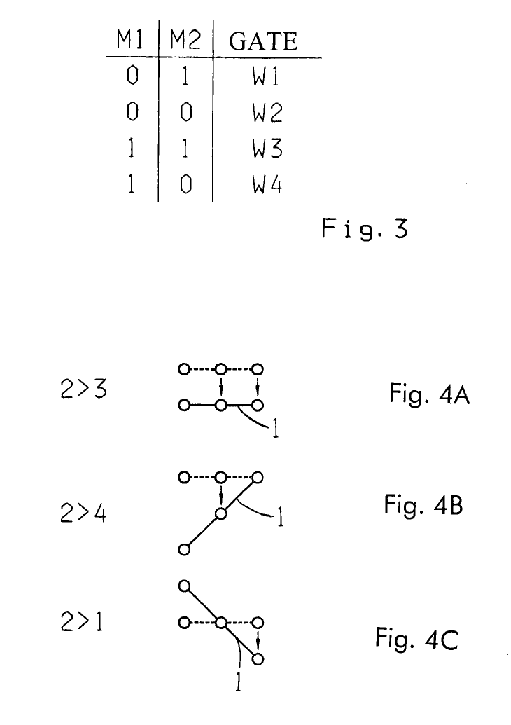

In the representation shown in FIG. 2, the end 2 of the selector rod 1 is in the first gate W1. As can be seen from FIG. 3, the actuator M1 is now in position 0 and the actuator M2 in position 1. To select gate W2, both actuators M1, M2 are moved to position 0. Moreover, gate W3 corresponds to position 1 for both actuators M1 and M2, and to select gate W4 the actuator M1 moves to position 1 and the actuator M2 to position 0.

For the selection positions that correspond to the middle gates W2 and W3 relative to an axis running parallel to the push-rods 8, 6 of the actuators M1, M2, as shown in FIG. 1 the push-rods 8, 6 of the actuators M1, M2 are arranged essentially perpendicularly to the longitudinal axis of the selector rod 1, whereas for the outer gates W1 and W4 relative to the axis running parallel to the push-rods 8, 6 of the actuators M1, M2 the selector rod 1 forms an angle with the push-rods 8, 6 of the actuators M1, M2 which is, respectively, larger or smaller than 90°. The corresponding angle for gate W1 is indexed a in FIGS. 1 and 2 and is larger than 90′; in FIG. 1 the angle between the push-rods 8, 6 of the actuators M1, M2 and the selector rod 1 is indexed β and is smaller than 90°.

In the example embodiment illustrated, and referring to FIGS. 4A, 4B and 4C, starting from the second gate W2, the third gate W3 is selected by a parallel displacement of the selector rod 1 produced by switching the actuators from position 0 to position 1, as shown in FIG. 4A. To select the fourth gate W4, the position of actuator M2 remains unchanged while actuator M1 is switched from position 0 to position 1, as shown in FIG. 4B. Moreover, staring from gate W2, gate W1 is selected by switching actuator M2 from position 0 to position 1, as shown in FIG. 4C, while the position of actuator M1 remains unchanged.

### INDEXES

1 Selector rod
2 End of the selector rod
3 Shifting device
4 End of the selector rod
5 Slot
6 Push-rod
7 Guide pin
8 Push-rod
9 Guide pin
M1 Second actuator
M2 First actuator
W1 Gate to be selected
W2 Gate to be selected
W3 Gate to be selected
W4 Gate to be selected
α Angle between the selector rod and the actuator push-rods
β Angle between the selector rod and the actuator push-rods

1-4. (canceled)

5. A shift gate selector for an automated transmission of a motor vehicle, the shift gate selector comprising:
a selector rod (1), and
first and second electromagnetic actuators (M1, M2) each being a bistable position magnet actively connected to the selector rod (1), the first and the second actuators (M1, M2) being arranged such that depending on a combination of positions of the first and the second actuators (M1, M2) one of four possible selection positions is obtained, and
each one of the four possible selection positions corresponding to a gate (W1, W2, W3, W4) to be selected.

6. The shift gate selector for an automated transmission of a motor vehicle according to claim 5, wherein a first end of the selector rod (1) is arranged in the shifting device (3) of the transmission for selecting the gates, and
a slot (5), arranged coaxially with the longitudinal axis of the selector rod (1), is provided at a second end (4) of the selector rod (1) in which is held a guide pin (7) connected with a push-rod (6) of the first actuator (M2), and
an opening is provided, in which is held a guide pin (9) connected to a push-rod (8) of the second actuator (M1), between the first and the second ends of the selector rod (1).

7. The shift gate selector for an automated transmission of a motor vehicle according to claim 6, wherein the first and the second actuators (M1, M2) are of identical structure and are arranged, relative to a longitudinal axis of the selector rod (1), on a common side of the selector rod (1) and in a common plane such that the push-rods (8, 6) are parallel to one another and substantially parallel to planes defined by the gates to be selected, such that as viewed along a longitudinal direction of the push-rods (8, 6), end positions of the push-rods (8, 6) corresponding to respective actuator positions are the same for the same such positions.

8. The shift gate selector for an automated transmission of a motor vehicle according to claim 5, wherein in the selection positions corresponding to middle gates (W2, W3) relative to an axis running parallel to the push-rods (8, 6) of the first and the second actuators (M1, M2), the push-rods (8, 6) of the first and the second actuators (M1, M2) are substantially perpendicular to the selector rod (1), such that the positions of the first and the second actuators (M1, M2) are the same in each case, and to select two outer gates (W1, W4) relative to the axis running parallel to the push-rods (8, 6) of the actuators (M1, M2), the first and the second actuators (M1, M2) are in respectively opposite positions such that the selector rod (1) is at an angle (α,β) with the push-rods (8, 6) of the first and the second actuators (M1, M2) which, respectively, are larger and smaller than 90°.

9. A shift gate selector for an automated transmission of a motor vehicle, the shift gate selector comprising a selector rod (1) having two ends, and first and second bistable position magnets (M1, M2), each being actively respectively connected to the selector rod (1) by a first and a second push-rod (6, 8) and arranged such that the selector rod (1) being positioned in one of four gates (W1, W2, W3, W4) depending on specific combinations of actuator positions of the first and the second actuators (M1, M2).

10. The shift gate selector for an automated transmission of a motor vehicle according to claim 5, wherein the first push-rod (8) is pivotally coupled to the selector rod (1) by a guide pin (9) and the second push-rod (6) is pivotally coupled to a remote end of the selector rod (1) by another guide pin (7), the selector rod (1) is positioned in a second gate (W2) when both of the first and the second actuators (M1, M2) are in a retracted position, the selector rod (1) is positioned in a third gate (W3) when both of the first and the second actuators (M1, M2) are in an extended position, the selector rod (1) is positioned in a first gate (W1) when the first actuator (M1) is in the retracted position and the second actuator (M2) is in the extended position and the selector rod (1) is positioned in a fourth gate (W4) when the first actuator (M1) is in the extended position and the second actuator (M2) is in the retracted position, in the second and the third gates (W2, W3) the selector rod (1) is perpendicular to both of the first and the second push-rods (6, 8) the first and the second push-rods (6, 8) being parallel to each other.
